(19) United States
(12) Patent Application Publication
(10) Pub. No.: US 2014/0299437 A1
(43) Pub. Date: Oct. 9, 2014

(54) FRICTION STARTER DRIVE UNIT FOR ENGAGEMENT WITH A STARTER RING GEAR OF A THERMAL ENGINE, AND STARTER OF A THERMAL ENGINE COMPRISING A STARTER DRIVE UNIT OF THIS TYPE

(71) Applicant: VALEO EQUIPMENTS ELECTRONIQUES MOTEUR, Creteil Cedex (FR)

(72) Inventors: Guillaume Seillier, La Verpilliere (FR); Alexis Chalmet, Lyon (FR); Christian Mornieux, Oullins (FR); Mathieu Metrop, Lyon (FR)

(73) Assignee: VALEO EQUIPEMENTS ELECTRIQUES MOTEUR, Creteil Cedex (FR)

(21) Appl. No.: 14/235,396

(22) PCT Filed: Jul. 24, 2012
(86) PCT No.: PCT/FR2012/051754

§ 371 Date: Jun. 27, 2014

(30) Foreign Application Priority Data
Jul. 26, 2011 (FR) 1156807

(51) Int. Cl. F02N 15/06; F16D 13/58; F16D 13/38

(52) U.S. Cl. CPC F02N 15/062; F16D 13/38; F16D 13/58
USPC 192/66.32; 192/66.3

(57) ABSTRACT

A friction starter drive unit for a starter, comprising: a pinion including a hole for the passage of a drive shaft; a drive part including a hole for the passage of a drive shaft, said drive part being mounted such as to be rotationally fixed with the pinion; a drive element including a hole for the passage of a drive shaft of a starter, which element can move in translation along axis X of the hole in relation to the drive part between an uncoupled position and a coupled position; and a friction coupling means arranged to couple the drive element to the drive part when the drive element is in the coupled position. The starter drive unit comprises a return means that exerts a force on the drive element and a force on the drive part in the direction of the uncoupled position.

### FIELD OF THE INVENTION

The present invention relates to a friction starter drive unit for engagement with a toothed starter ring gear of a thermal engine, in particular of a motor vehicle.

The object of the present invention is also a starter of a thermal engine, in particular of a motor vehicle, comprising an assembly of this type.

### PRIOR ART

Starters with starter drive units are known such as the one described in document FR1056174. FIG. 1 represents a starter with a starter drive unit schematically, in a simplified manner. As can be seen in FIG. 1, a starter 1 with a starter drive unit of a thermal engine, in particular of a motor vehicle, comprises:
a housing 11 connected to the earth of a battery;
a drive shaft 15 comprising an axis X, which is rotated by the housing 11 by means of a front bearing 11A;
a friction starter drive unit 2 which is mounted such as to slide on the drive shaft 15, the said starter drive unit 2 comprising a pinion 21 which is mounted on the drive shaft 15, and can slide axially on this shaft 15, the said pinion 21 being able to engage in a toothed starter ring gear C of the thermal engine;
a control lever 3 which forms a mobile assembly with the starter drive unit 2, the control lever 3 being configured to control the displacement of the starter drive unit 2 and the engagement of its pinion 21 with the ring gear C;
a means for manoeuvring the control lever 3, in this case a contactor 4 which is supported by the housing 11; this means for manoeuvring being controlled by a contact 4a, for example a key contact of a vehicle;
an electric motor M which is accommodated in the housing 11, and is provided with a rotor shaft 5, a stator 6 and a collector 51;
a reduction gear system 7, for example an epicycloidal reduction gear which connects the drive shaft 15 to the rotor shaft 5.

The means for manoeuvring controls the control lever 3 when starting of the thermal engine is required, either manually and/or automatically. The control lever 3 advances the starter drive unit 2 in the direction of a toothed belt¹ C which is coupled in rotation with the crankshaft of the thermal engine, until the pinion 21 is engaged with the toothed belt C. The starter drive unit 2 couples the drive shaft 15 with the pinion 21. The electric motor M rotates the crankshaft of the thermal engine (not represented) by means of the pinion 21 and the ring gear C.

Different types of starter drive units 2 exist, for example friction starter drive units, or free wheel starter drive units with rollers. The invention relates to friction starter drive units. Examples of friction starter drive units are described in patent applications FR1056174 and WO2006/100353.

Friction starter drive units comprise a drive element 22 which is mounted on the drive shaft 15 by means of ribbing, a drive part 23 which is integral in rotation with the pinion 21, and is also known as the drive flange or coupling part, and a clutch system 24.

The clutch system 24 makes it possible to render the drive part 23 and pinion 21 assembly integral in rotation with the drive element 22. Thus, the pinion 21 is free in rotation relative to the drive shaft 15 when the clutch system 24 is deactivated (in the disengaged position), and is integral in rotation with the drive shaft 15 when the clutch system 24 is activated (in the engaged position).

The clutch system 24 comprises at least a pressure plate 245a which is integral in rotation and in translation with the drive element 22, and a reaction plate 245b which is integral in rotation and in translation with the coupling part 23. The clutch system 24 comprises friction linings.

The clutch system 24 is of the disc type. A system of this type is described in application FR1056174. The clutch system 24 comprises at least two discs, i.e. an inner disc and an outer disc made of friction material. The inner disc(s) is/are integral in rotation with the drive element 22, and the outer disc(s) is/are integral in rotation with the gear part 23. The inner discs are mounted around a part of the drive element 22, and can slide along this part which forms the outer periphery of the drive element. The outer discs are mounted in the interior of a part of the drive part 23, and can also slide in the interior of the drive part 23. The connections between the discs and the drive part 23 or the drive element 22 can consist of notches and complementary grooves.

The clutch system is activated when the pressure plate 245a of the drive element 22 compresses the friction linings (for example the inner and outer disks) against the reaction plate 245b of the drive part 23, by means of the discs in the case of a starter drive unit with discs.

The drive element 22 is thus mobile relative to the drive part 23. The pressure plate 245a compresses the friction linings against the reaction plate 245b when the drive part 23 is blocked in translation in the direction of the ring gear C, and when the electric motor M rotates the drive shaft 15 faster than the pinion 21, which is rotated by the ring gear. The rotation of the drive shaft 15, by means of the ribbing, exerts a force on the drive element 22 in the direction of the ring gear C.

The drive element 22 comprises at least one part 22a which is enclosed in the drive part 23. Broken lines represented in FIG. 1 delimit, in this position of the drive element relative to the drive part 23, the front part of the drive element 22 enclosed in the drive part, and the rear part of the drive element 22. The drive element 22 is thus coupled with the drive part 23. The part 22a comprises the pressure plate 245a and the inner discs, in the case of a starter drive unit with discs.

The control lever 3 of the starter drive units can advance the starter drive unit 2 in order to engage its pinion 21 in the ring gear C in two ways. A first way is that the control lever 3 is designed to thrust the drive element 22 which can activate the clutch, and thus be coupled with the drive part 23. By this means, the control lever 3 initially thrusts the drive element 22, then, in a second stage, it thrusts the assembly of the pinion, the drive element and the drive part towards the ring gear C by means of the drive element.

The other way consists of the lever thrusting the drive part 23 directly, thus displacing all the units of the starter drive unit 2. The drive element 22 is thrust in the direction of the belt C into the uncoupled position by means of the drive part 23. This way of operating is described in particular in patent application FR1056174.

In both cases, the drive element 22 is mobile in translation relative firstly to the drive shaft 15, and secondly relative to the drive part 23.

In these two ways of operating, in the state of rest of the starter, i.e. when the control lever 3 is in the deactivated position and the electric motor is not supplied with power, the drive element 22 is separated from the drive part 23. Consequently, the pinion, the drive part and the drive element are not retained, i.e. they are not immobilised. When the vehicle is started, the starter receives vibrations, in particular those caused by the vibrations of the thermal engine in the operating state, and those caused by the vibrations from the road when the vehicle is travelling. The vibrations cause noise and wear on the starter drive unit 2, in particular on the ribbing of the drive element 22 and the bearings between the pinion 21 and the drive shaft 15.

### OBJECT OF THE INVENTION

The object of the present invention is to reduce the noise and vibrations within the context of a friction starter drive unit.

According to the invention, the friction starter drive unit for a starter comprises:
a pinion comprising a bore for the passage of a drive shaft;
a drive part comprising a bore for the passage of a drive shaft, the drive part being mounted integrally in rotation with the pinion;
a drive element comprising a bore for the passage of a drive shaft of a starter, which is mobile in translation according to the axis X of the bore relative to the drive part, between an uncoupled position and a coupled position;
a coupling means comprising a friction clutch comprising a plate for pressure on the drive element and a plate for reaction on the drive part, and wherein the friction clutch is a disc clutch which is designed to couple the drive element with the drive part when the drive element is in the coupled position,
   characterised in that the starter drive unit comprises a return means which exerts a force on the drive element, and a force on the drive part in the direction of a position of uncoupling, as far as a position of uncoupling in rotation, and in that, in this position of uncoupling in rotation, the drive element and the drive part are immobile in translation relative to one another, whilst being free in rotation relative to one another.

Thus, the return means immobilises the drive element relative to the drive part in the position of rest, i.e. when the drive element is in the uncoupled position. This makes it possible to reduce the vibrations of the drive element, and thus to reduce the noise caused by the vibrations of the drive element, and also to reduce the wear of the drive element. The return means is thus designed to thrust the drive element until a surface of the drive element is supported against a surface of the drive part, or is connected in translation with the latter. The two surfaces in contact have surface friction properties which are distinctly inferior to those of the surfaces of the friction discs, such that the drive element is not coupled in rotation with the drive part.

According to other characteristics of the starter drive unit, taken in isolation and/or in combination:
the return means exerts a force by thrusting the drive element and the drive part in the direction of the uncoupled position;
the return means exerts a force by drawing the drive element and the drive part in the direction of the uncoupled position;
the drive part comprises a part which forms a casing which surrounds part of the drive element, wherein the starter drive unit additionally comprises a ring which is secured to the drive part, comprising a surface which faces a surface of a shoulder of the drive element which is enclosed in the casing, and wherein, in the uncoupled position, the return means exerts a force on the drive element against the surface of the ring;
the return means is mounted with compression against a radial inner surface of the drive part and a front surface which forms an axial end of the drive element situated in the interior of the drive part, in order to separate the drive element from the drive part;
the coupling means comprises a friction clutch, comprising a plate for pressure on the drive element and a plate for reaction on the drive part;
the friction clutch is a disc clutch;
the pressure plate and the reaction plate each comprise a friction skirt which are designed to be placed one against the other in the coupled position;
the drive part comprises a first part on which the pinion is mounted, and a second part which surrounds a part of the drive element, wherein the pinion slides on the first part of the drive part, and is integral in rotation in both directions with the drive part, and the starter drive unit additionally comprises a spring which is mounted between the radial rear surface of the pinion which faces the radial front surface of the second part of the drive part;
the pinion is secured on a part of the drive part;
the return means is a spring washer.

The invention also relates to a starter of a thermal internal combustion engine, in particular of a motor vehicle, and is characterised in that it comprises a starter drive unit of this type.

According to other characteristics, taken in isolation and/or in combination, the starter can additionally comprise:
a drive shaft and the starter drive unit are mounted integrally in rotation on the drive shaft, and are mobile on the latter between a disengaged position and an engaged position;
a control lever which is mobile from an activated position to a deactivated position;
a means for activation of the control lever;
an electric motor to rotate the drive shaft,
   wherein the starter drive unit comprises a withdrawal shoulder and at least one advance shoulder which is designed to co-operate with part of the control lever, wherein the return means is designed to exert a force on the drive element towards the uncoupled position, and wherein the force of the return means is lower than the force exerted by the lever on the drive element, when the latter is in the coupled position;
the part of the lever which co-operates with the starter drive unit comprises projections which are designed in order:
   in a first stage, when the control lever is displaced from its deactivated position to the activated position, to thrust the drive part onto a surface of a shoulder which is integral with the drive part, in the direction of the engaged position, opposite the electric motor;
   in a second stage, at a predetermined distance corresponding to the pinion engaged in the ring gear, to thrust the starter drive unit, onto a surface of advance of a shoulder which is integral with the drive element, towards the engaged position, and wherein:
   when the pinion is blocked in translation towards the engaged position, or is in the engaged position, the part of the lever is designed to thrust on the surface of a shoulder which is integral with the drive element, in the direction of the coupled position, towards the drive part which compresses the return means; and
   wherein the return means is designed such as, when the control lever is in the deactivated position, to maintain the drive element in the uncoupled position, against a shoulder which is integral in translation with the drive part;
a housing;
a drive shaft which compresses a shaft, which is rotated by the housing by means of a front bearing;
an electric motor comprising a rotor shaft, which is coupled in rotation with the drive shaft,
   wherein the starter drive unit comprises:
a drive element which is mounted by means of the ribbing on the drive shaft;
a pinion which can be displaced according to the axis, relative to the drive shaft, and can be free in rotation relative to the drive shaft;
a drive part which is integral in rotation with the pinion, comprising a skirt which surrounds a part of the drive element;
a system for coupling between the drive element and the pinion;
a thrust plate which is secured to the skirt of the drive part, which closes the skirt and encloses the part of the drive element in the skirt;
wherein the drive element is mobile in translation according to the axis, relative to the drive part, between a so-called coupled position in which it activates the coupling system, and an uncoupled position in which the coupling system is deactivated;
a plate which forms a shoulder relative to the drive element, and is integral in translation with the drive element;
a control lever means which is designed to make it possible:
in a first stage, to displace the drive part according to the axis in the direction of the front bearing, relative to the drive shaft, by thrusting the thrust plate; and
in a second stage, to displace the drive element according to the axis in the direction of the front bearing, relative to the drive part, as far as the coupled position.

Other characteristics and advantages of the invention will become apparent from reading the following non-limiting description, for understanding of which reference will be made to the attached drawings.

### BRIEF DESCRIPTION OF THE DRAWINGS

FIG. 1 represents schematically, in a simplified manner, a starter according to the prior art.

FIG. 2a represents an axial cross-section of a starter drive unit according to the first embodiment.

FIG. 2b represents an enlargement of an area of FIG. 2a.

FIG. 3 represents an axial cross-section of a starter comprising a starter drive unit according to FIG. 2a.

FIG. 4 represents an axial cross-section of a second embodiment of a starter drive unit mounted on a drive shaft, in an uncoupled position.

FIG. 5 represents the second embodiment of the starter drive unit represented in FIG. 4, mounted on a drive shaft, in a coupled position.

FIG. 6 represents an axial cross-section of a starter drive unit according to a third embodiment of the invention.

### DESCRIPTION OF EMBODIMENTS OF THE INVENTION

In the figures, elements which are identical, similar or analogous are designated by the same reference numbers.

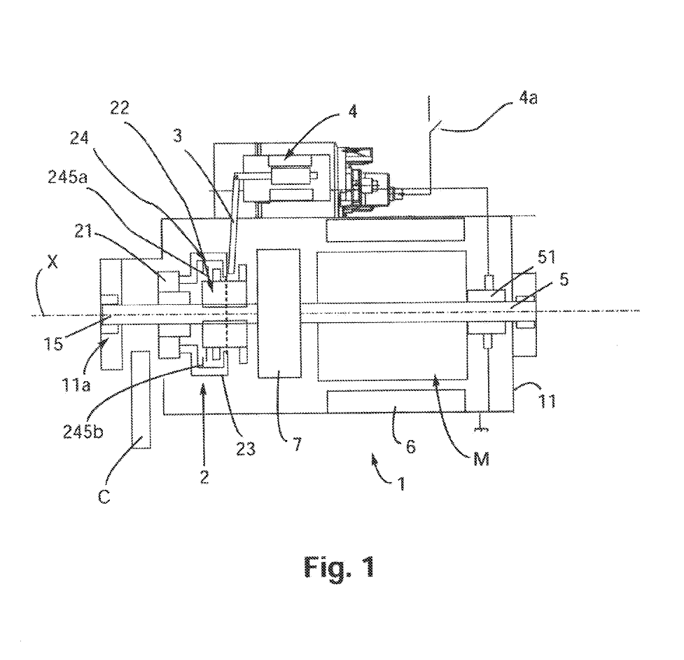

An orientation from the front to the rear corresponds to an orientation from left to right in FIGS. 1, 2a, 2b, 3, 4, 5 and 6. In this case, a front surface is a surface which faces in the direction of a front bearing of the starter supporting its drive shaft, and a rear surface is a surface which faces in the direction of a rear bearing supporting a rotor shaft of the starter.

A type of friction starter drive unit according to the prior art will now be described in greater detail.

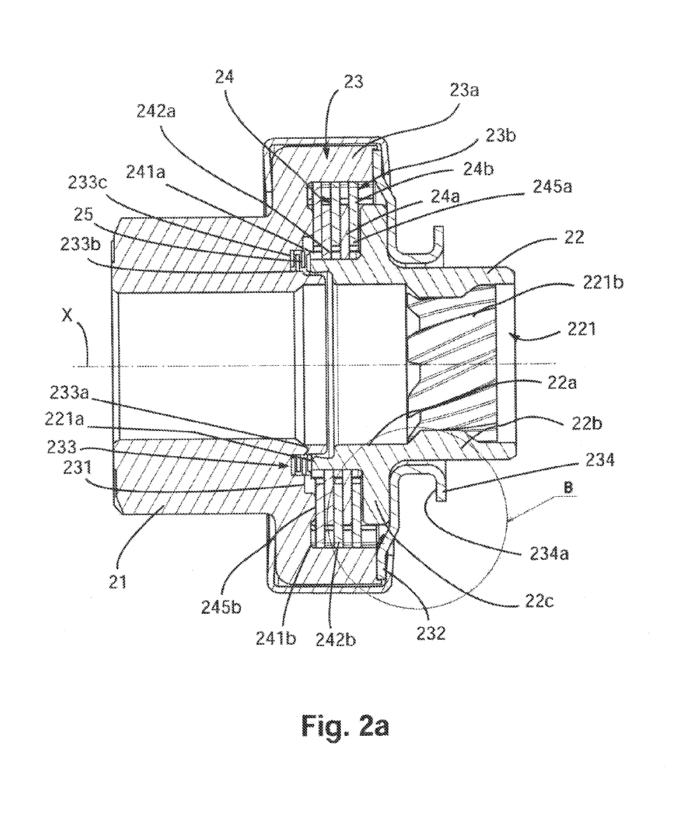

FIG. 2a represents a friction starter drive unit of a starter in cross-section. The friction starter drive unit represented is a friction starter drive unit with a disc 2 (known hereinafter in the description as starter drive unit with a disc 2 or starter drive unit 2), but other friction starter drive units also exist, such as the friction starter drive units with a cone.

A description will now be provided of the starter drive unit with a disc represented in FIG. 2a. The starter drive unit 2 comprises at the front a pinion 21, and at the rear a drive element 22, and between the two a drive part 23.

The drive element 22 comprises a cylindrical bore 221 with an axis X, to be mounted around a drive shaft of the starter. The drive element 22 has a front section 22A with a smooth bore, and a rear section 22b comprising ribbing 221b which corresponds to ribbing on the drive shaft.

The front end of the drive element 22, which in this case is the front end of the front section 22a, forms a stop 221a. When the starter drive unit is mounted on the drive shaft, the ribbing 221b surrounds the ribbing of the drive shaft. This therefore forms a system of the screw-nut type with tapping and a thread. The drive element 22 is thus driven with a movement of rotation and translation along a drive shaft, when it is displaced by the lower end of a control lever. The drive element is thus separated in translation and in rotation relative to the drive shaft, when it is displaced on this shaft.

The pinion 21 is secured to the front end of the drive part 23, which is extended at the rear, in order to form, so as to provide an excess thickness, a hollow skirt 23a which forms a casing 23b, by means of an inner bore in the drive part.

Secured means integral in rotation and in translation.

The drive part 23 and the pinion 21 comprise a bore into which there is inserted a section of the drive shaft, and they are guided axially on a smooth section of the drive shaft. When the starter drive unit is mounted on the drive shaft, needle bearings can be interposed between the smooth section and the pinion 21 and/or the drive part 23.

The starter drive unit 2 comprises a disc clutch 24 in the casing 23b, the disc clutch 24 comprises inner 24a and outer 24b discs, and in this case three outer and two inner discs. The clutch 24 additionally comprises the front section 22a of the drive element 22. This section 22a is extended on its outer periphery by grooves 241a with axial orientation which extend towards the front. These grooves are configured on the interior to form receptacles for lugs 242a of the inner discs 24a.

The drive element 22 additionally comprises a shoulder 22c which extends towards the exterior relative to the two front and rear sections, situated between the front section 22a and the rear section 22b. This shoulder 22c comprises a front surface which forms a pressure plate 245a of the clutch. The shoulder 22c is situated in the casing 23b.

The clutch additionally comprises a part of the skirt 23a at the rear of the drive part 23. The front section 22a, the shoulder 22c, the inner discs 24a and the outer discs 24b are inserted in the casing 23b. The casing 23b comprises inner grooves 241b situated on the inner periphery of the bore in the skirt 23a. Lugs 242b of the outer discs 24b are inserted in the grooves 241b.

The starter drive unit 2 additionally comprises a plate 232, known as the thrust plate, which is secured, to the rear of the skirt 23a of the drive part 23. This thrust plate 232 closes the rear of the skirt 23a, therefore closing the casing 23b. Thus, the shoulder 22c, the front section 22a, the inner discs 24a and the outer discs 24b are enclosed in the casing 23b formed by the inner bore in the drive part 23. The skirt 23a comprises in the casing 23b an inner radial surface and a reaction plate 245b, which in this ease projects from this radial surface. The plate 232 is secured, to the drive part 23 by means of a plate which forms a cover, but it could also be snapped on, or welded, or secured by any other securing means such as, for example, screws, onto the drive part 23. The thrust plate 232 comprises two surfaces 232a and 232b shown in FIG. 2b, which represents an enlargement of a part of the starter drive unit 2. The surface 232a is opposite a shoulder surface 22c. The thrust plate is designed such that the surface 232b, known as the thrust surface 232b, is situated opposite the lower end of the control lever, such that it co-operates with the thrust plate, in order to thrust the starter drive unit 2 assembly.

The starter drive unit 2 additionally comprises a draw plate 234. This draw plate 234 is mounted such that one of its surfaces 234a, known as the draw surface 234a, is opposite the thrust surface 232b.

In this embodiment, the thrust plate 232 is integral with the draw plate 234. The two plates are rendered integral by means of a sleeve, and together form a ring. In this case, the ring is integral with the drive part 23.

The sum of the axial lengths of the inner 24a and outer 24b discs and of the shoulder 22c is smaller than the axial distance between the reaction plate 245b and the surface 232a of the thrust plate 232. This difference in length is known hereinafter as the play A, the play A being represented in FIG. 2b. The starter drive unit thus comprises play A or series of distributed play, the sum of which is equal to the play A, between the reaction plate 245b, the inner 24a and outer 24b discs, the shoulder 22c and the thrust plate 232. In FIGS. 2a and 2b the drive element is in a non-coupled position.

The starter drive unit 2 additionally comprises a return means 25 which exerts a force which spaces the drive element 22 from the drive part 23 in the direction of the uncoupled position. In other words, the return means exerts two opposite forces, i.e. one on the drive element 22 rearwards, and the other on the drive part 23 forwards. In this case, the return means 25 is mounted in a compressed manner against a radial inner surface of the drive part 23 and the front surface which forms the stop 221a of the drive element 22, in order to separate the drive element 22 from the drive part 23.

In this case, the drive part 23 comprises a circular groove 233 around the axis X with an axial depth, facing the radial surface which forms a stop 221a of the front end of the drive element 22. The groove 233 is open axially and closed radially by two axial sides 233a and 233b forming two peripheral surfaces which surround the axis X. The base 233c of the groove 233 is radial. The return means 25 comprises a part which is situated in the groove 233 in the drive part 23. The return means 25 is mounted in a compressed manner between the base 233c of the groove 233 in the drive part 23 and the stop 221a of the drive element 22, in order to separate the drive element 22 from the drive part 23. In this case, the return means 25 is a helical spring. The return means could be a spring strip or a spring washer. The return means can have one of its ends secured to the starter drive unit or to the drive part.

When the drive part 23 turns relative to the drive element 22, the end(s) pressed against the drive part, or the starter drive unit, can rub against this support surface. This surface can advantageously be covered with a coating which makes it possible to reduce the wear of the return means 25.

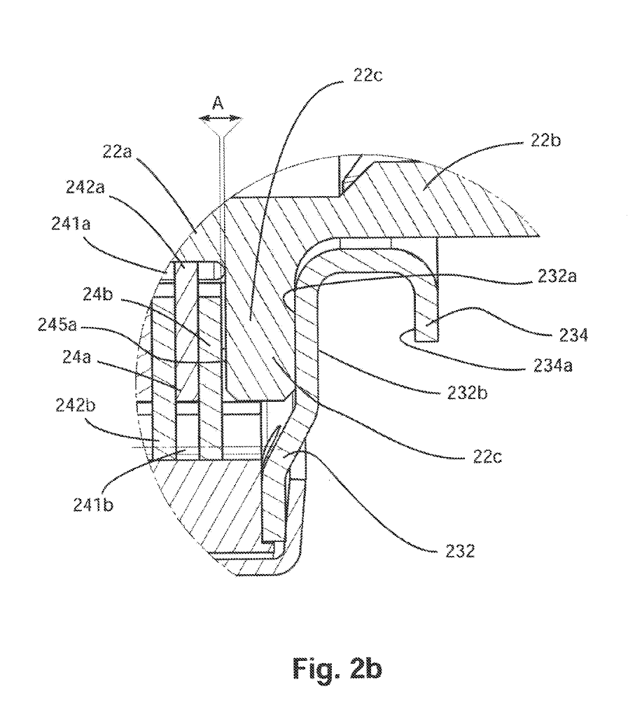

FIG. 3 represents a starter 1 comprising a starter drive unit 2 as represented in FIG. 2a.

The starter 1 comprises:
a housing 11 connected to the earth of a battery;
a drive shaft 15 which is rotated by the housing 11 by means of a front bearing 11A;
the friction starter drive unit 2 as described with reference to FIG. 2a, mounted such as to slide on the drive shaft 15;
a control lever 3 forming a mobile assembly together with the starter drive unit 2, and configured to control the displacement of the starter drive unit 2 and its engagement with a toothed starter ring gear C of the thermal engine;
a means for manoeuvring the control lever, in this case a contactor 4 which is supported by the housing 11; this means for manoeuvring being controlled by a contact 4a, for example a key contact of a vehicle;
an electric motor M which is accommodated in the housing 11 and is provided with a rotor shaft 5, a stator 6 and a collector 51;
a reduction gear system 7, for example an epicycloidal reduction gear which connects the drive shaft 15 to the rotor shaft 5.

The housing 11, which in this case is made of metal and is connected to the earth, comprises a front bearing configured for mounting with rotation of the front end of the drive shaft 15, and securing of the starter on a fixed part of the vehicle which is connected to the earth of the latter, a rear bearing configured for mounting with rotation of the rear end of the rotor shaft 5, and a cylindrical intermediate head which is sandwiched between the bearings.

The front bearing of the starter 1 comprises an opening in its lower part for passage of the starter ring gear C which is designed to be rotated by means of the starter drive unit 2 by the electric motor M when it is supplied electrically. The upper part of the front bearing supports the body of the contactor 4, which in this case is implanted above the electric motor M.

In this case, the collector is of the type with axial orientation and the brushes have orientation which is radial relative to the axis X.

As a variant, the collector can be frontal, and the brushes can have an orientation which is axial relative to the axis X of the rotor shaft 5, as in document GB 225 757.

One of the brushes is connected to the earth, and the other is connected to the positive terminal of the battery of the vehicle, in the manner described hereinafter. Advantageously, in order to reduce the wear of the brushes, several pairs of brushes are provided.

The head of the housing 11 supports in its interior the stator 51 comprising an inductor winding, or as a variant permanent magnets, for example of the type described in document GB 225 757.

The control lever 3, which is advantageously made of plastic material for reduction of noise, is mounted at an intermediate point on a support made of rigid plastic, in a manner which is articulated relative to the head 11. For further details, consult document FR 2 725 758.

The control lever comprises at one of its ends a lower end portion 3a, a part of which is situated between the thrust surface 232b and the draw surface 234a. It additionally comprises on its other end an upper end portion 3b, a means for connection with the means for manoeuvring 4, and, between the two ends, a portion to act as a lever which forms a pivoting point 3c on a part which is integral with the housing 11.

The means for manoeuvring 4 comprises an electromagnetic contactor 4 provided with a body which is supported by the housing 11, and has mobile control rod 42—mobile contact 43 equipment, and a lever rod 45 which is connected to the upper end of the control lever 3, in order to make the latter pivot so as to displace its lower end towards the ring gear C. It also comprises a mobile core 41 which surrounds the lever rod 45.

The contact 43 is a mobile plate which is mounted such as to slide on the rod 42, between an advanced position of rest and an active withdrawn position, by means of springs. Similarly, the lever 3 is mounted in an articulated manner on the rod 45 and on the support which is integral with the head 11, in order to displace the starter drive unit 2 axially between a withdrawn position of rest and an advanced active position in which the pinion 21 abuts a stop 25 which is mounted on the drive shaft 15 between the starter drive unit 2 and the front bearing 11a.

This mobile core 41 is configured to act on the mobile equipment and displace it in the direction of heads of fixed electric contact terminals 44a, 44b, in order to supply the electric motor M by means of a cable 441b.

The starter ring gear C can consist of a ring gear which is toothed on the exterior (FIG. 3) and is integral with a plate which is connected in a rigid or resilient manner to the crankshaft of the thermal engine, as in documents FR 2 631 094 and GB 225 757. As a variant, the starter ring gear C can consist of a ring gear which is toothed on the interior, and is integral with a pulley which belongs to a belt movement transmission which intervenes between this pulley and a pulley which is integral with the crankshaft, as described in document FR 2 858 366.

The shaft of the rotor 5 of the electric motor M can either be combined with the drive shaft 15 of the starter 4, as described for example in document GB 225 757, or it can be distinct from this shaft 15; at least a speed reducer 7 being interposed between the shafts 15, 5, as shown in FIG. 3 and as described in documents FR 2 631 094 and FR 2 858 366.

The speed reducers 7 make it possible to use a faster electric motor, and to obtain a higher starting torque, whilst reducing the size and weight of the starter for a given power. These reducers 7 are mostly reduction gears, either with an epicycloidal train, in which case the shafts 15, 5 are coaxial (see FIG. 3), or have internal gears as described in document FR 2 631 094, in which case the shafts 15, 5 are offset radially relative to one another. As a variant, the speed reducer 7 can be of the type described in FIGS. 2 to 5 of document FR 2 787 833. This reduction gear can have another form, and in particular can comprise a torque limiter as in document FR 2 631 094.

The lever rod 45 passes through the mobile core 41, which rod 45 is configured to receive at its front end an upper articulation shaft for mounting in a pivoting manner of the upper end of the lever 3, which in this case comprises an intermediate articulation shaft.

A spring 46, known as a tooth-against-tooth spring, which in this case is helical, is mounted in the mobile core 41 around the rod 45. This spring 46 is supported on the base of this core 41 and on the shouldered head of the rod 45.

The contactor 4 additionally comprises a coil 47 which, when it is activated electrically, further for example to the activation of the contact key, creates a magnetic field which controls the axial displacement of the mobile core 41 in the direction of a fixed core 48.

Finally, the contactor 4 comprises a return spring 49, which in this case is helical, mounted around the front end of the mobile core 41, and implanted between the front end of the head of the contactor and a metal stop which is secured on the front end of the mobile core 41, in order to return the mobile core 41, and thus the pivoting lever 3, to their withdrawn position of rest (FIG. 3), when the coil 47 is not supplied electrically.

The displacement of the mobile core 41 displaces the rod 45 and the mobile contact (plate) 43 until they are in contact with heads of the terminals 44a, 44b, in order to establish electrical contact and to supply electrically the electric motor M, which then rotates the drive shaft 15 by means of the rotor shaft 5 and the reduction gear 7. It will be appreciated that the contactor could, operate differently, and could be structurally different, such as, for example, it could comprise two coils, one to control the displacement of the lever 3 and the other to control the displacement of the contact 43.

By means of the lever rod 45, the displacement of the mobile core 41 also gives rise to displacement of the control lever 3 at the level of its upper end, and to pivoting of the latter.

The lower end of the lever 3 then displaces the starter drive unit 2 axially forwards along the drive shaft 15 of the starter 1 in the direction of the stop 25 integral with the front end of the drive shaft 15 which is fitted such as to rotate in the front bearing, which in this case is a smooth bearing. The displacement of the low end of the lever 3 towards the ring gear C exerts a force in the direction of the ring gear C on the thrust plate 232. The lever 3 thrusts the thrust plate 232 and displaces the drive part 23 and the pinion 21 relative to the drive shaft 15. During the displacement of the mobile contact 43 towards the two terminals 43a, 43b as a result of the return means 25, and when the electric motor M is not yet supplied, the shoulder 22c is in contact with the thrust plate 232, i.e. in the uncoupled position. The drive element 22 is thus displaced relative to the drive shaft 15 in the direction of the ring gear, by means of the thrust plate 232 and the lever 3.

The contactor 4 thus has two functions, i.e. the displacement of the mobile contact 43 in order to control the supply of the electric motor M, and the displacement of the control lever 3—starter drive unit 2 assembly in the direction opposite that of the displacement of the mobile contact 43.

When the electric motor M is supplied, the drive shaft 15 is rotated. The rotation of the drive shaft 15 drives the drive element 22 to the coupled position, by means of the helical ribbing. In the coupled position, the play A is situated between the shoulder 22c and the inner surface of the thrust plate 232. The drive element 22 is positioned such that the inner and outer disks 24a, 24b are compressed between the thrust plate 221c and the reaction plate 245b. Consequently the drive element 22 is coupled with the drive part, and the pinion 21 is therefore coupled in rotation with the drive shaft 15.

When the power of the coil 47 is switched off, the mobile core 41 is no longer attracted magnetically rearwards, and the control rod 3 is thrust forwards by means of a spring, shown but not numbered, until the mobile contact 43 abuts the fixed core 48.

The return spring 49 also intervenes in order to return the mobile core 41 and the lever 3 to their withdrawn position of rest which can be seen in FIG. 3. Consequently the lever 3 displaces the starter drive unit 2 rearwards, i.e. towards the electric motor M, by thrusting on the draw surface 234a of the draw plate 234. When the mobile contact 43 is no longer in contact with the heads of the terminals 44a, 44b, the motor is no longer supplied, and the rotor shaft 5 stops rotating. Consequently the difference in the speed of rotation between the pinion 21 and gear part 23 assembly, relative to the drive shaft 15, displaces the drive element 22 to the uncoupled position. The return means 25 assists the displacement of the drive element 22 in the direction of the uncoupled position. This return means 25 allows the drive element to be displaced more rapidly from the coupled position to the uncoupled position.

This makes it possible to ensure that the drive element 22 is in the uncoupled position when the pinion 21 is no longer engaged with the ring gear C, and thus to prevent milling in the case of a new supply to the coil 47. In addition, when the rotary electrical machine 1 is not supplied electrically, this makes it possible to prevent the drive element 22 from being in the coupled position. In fact, without this return means, the lever 3 thrusts the draw plate 234 which draws the pinion and gear part 23 assembly rearwards, with the latter thrusting the drive element 22 to the coupled position by means of the reaction plate 245b, the discs and the pressure plate 245a. Thus, in this embodiment, the drive element 22 is in the uncoupled position when the electric motor M is no longer supplied.

Another solution to prevent this disadvantage consists of rendering the draw plate integral with the drive element 22, as described in document FR1056174. However, the embodiment according to the invention makes it possible to be more rapid in disengaging the pinion 21 from the ring gear C than in the embodiment described in document FR1056174, since the latter draws the drive element firstly into the uncoupled position, before drawing the pinion 21 to the disengaged position.

In addition, once the lever 3 is in the position of rest, the return means 25 makes it possible to immobilise the drive element 22 with the drive part 23. This makes it possible to prevent the vibrations from causing premature wear of the parts.

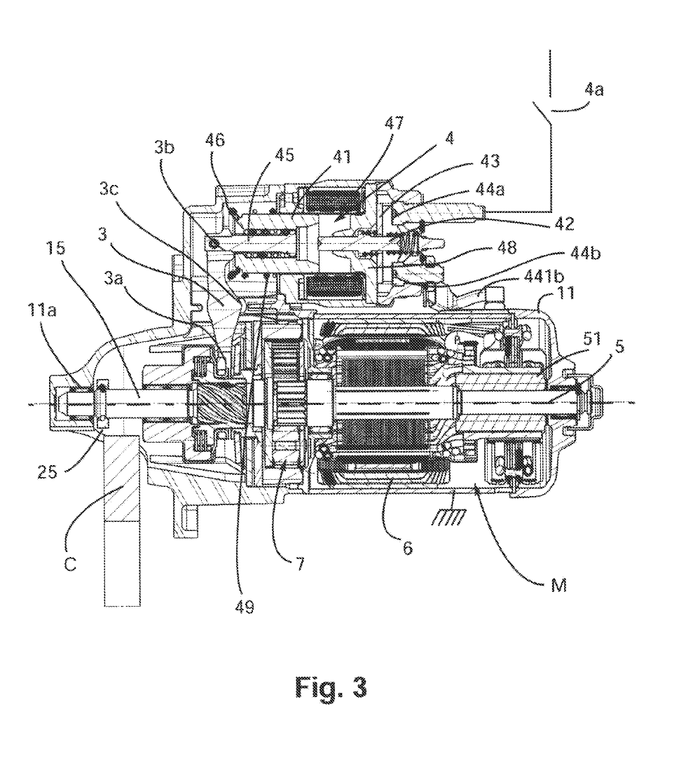

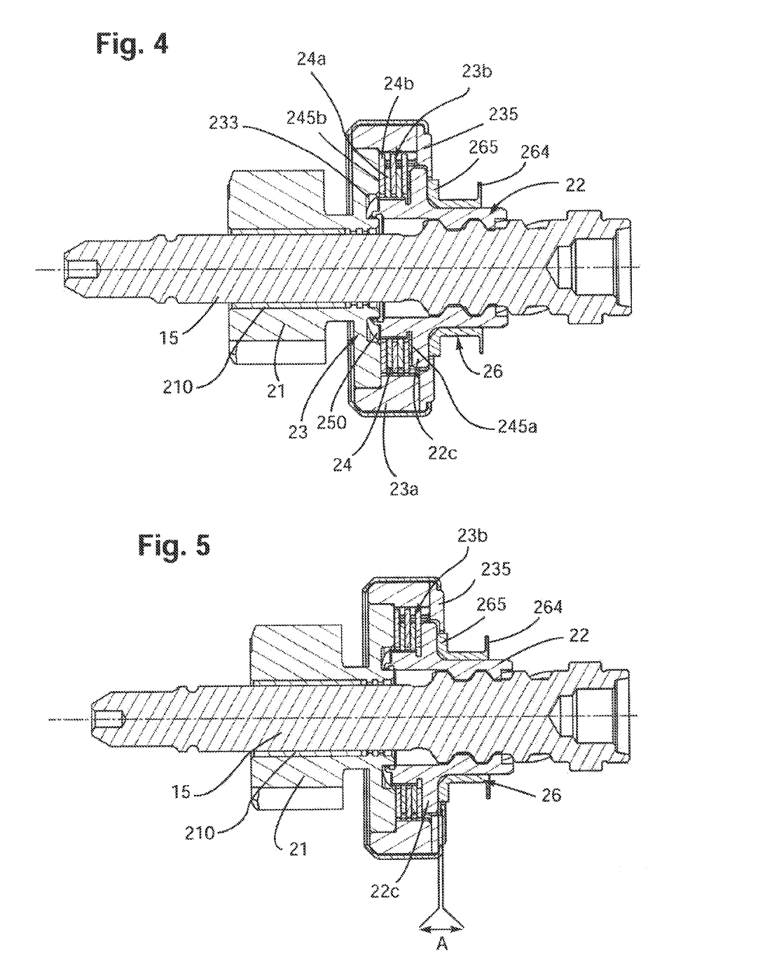

FIGS. 4 and 5 represent a view in axial cross-section of a starter drive unit 20 according to another embodiment, mounted on a drive shaft 15. This can be mounted instead of, and in the place of, the starter drive unit 2 previously described in the starter represented in FIG. 3.

Like the starter drive unit 2 in FIG. 2a, this starter drive unit 20 comprises a pinion 21, a drive element 22 and a friction clutch 24 which intervenes between the drive element 22 and the pinion 21, and is identical to that in FIG. 2a. Like the friction clutch in the embodiment previously described, this friction clutch comprises at least one inner 24a and outer 24b friction disc, a pressure plate 245a and a reaction plate 245b. In FIG. 4, the drive element 22 of the starter drive unit 20 is in the uncoupled position. In FIG. 5, the drive element 22 of the starter drive unit 20 is in the coupled position. In both figures the starter drive unit 20 is mounted on the drive shaft 15.

The pinion 21 is mounted on the drive shaft 15 by means of a sleeve 210. This sleeve makes it possible to guide the pinion 21 on the drive shaft 15 in translation, and to reduce the friction caused by the difference in rotation between the pinion 21 and the drive shaft 15.

The starter drive unit 20 is identical to the starter drive unit 2, except as far as the elements described hereinafter are concerned.

The return means 25 is a spring washer 250. It is mounted in the groove 233 in the drive part 23, and around a periphery which forms the end of the drive element 22. The return means is supported firstly against a radial surface which forms the base of the groove 233, and also against a radial surface of the shoulder of the drive element 22. This shoulder makes it possible to retain the spring washer 250 radially. According to another embodiment, the spring washer 250 is replaced by a helical spring, as in the embodiment represented in FIG. 2a. In this example, the end of the helical spring would surround the periphery which forms the end of the drive element, in order to retain it radially.

In this embodiment, the starter drive unit 20 comprises two thrust plates, i.e. a thrust plate 235 which is integral with the drive part, and another thrust plate 265 which is integral with the drive element. The thrust plate 265 forms part of a ring 26 which is mounted at least integrally in translation with the drive element 22. In this case, it is mounted in a clamped manner on the outer periphery of the drive element 22, but could also be mounted with play on the drive element, for example it can be retained in translation by the shoulder 22c and a means for blocking in translation such as an outer resilient ring. This ring 26 additionally comprises a draw plate 264. Thus, the draw plate 264 is integral at least in translation with the drive element 22 and not with the drive part 23 as in the embodiment previously described, represented in FIG. 2a. The drive element 22 could be in a single piece with the ring 26.

In this embodiment, the two thrust plates make it possible to thrust the starter drive unit 20 in two ways. In a first way, the control lever is designed to thrust the drive part 23 directly, and in the second way the lever thrusts the drive element 22, in this embodiment, the starter comprises a control lever means which makes it possible in a first stage to thrust the drive part 23 by thrusting the thrust plate 235, and in a second stage to thrust the drive element 22 by means of the thrust plate 265. During the second stage, the thrust plate 265 partly enters the casing 23b of the skirt 23a of the drive part 24. This makes possible a saving in axial space for the starter. In this embodiment, the control lever means preferably displaces the drive element only when the starter drive unit has been displaced at least as far as a position which is predetermined relative to the drive shaft, between the engaged position and the position of rest. The predetermined position preferably corresponds to a position in which the starter drive unit 22 is close enough to the front bearing 11a for the pinion 21 to be in the tooth-against-tooth position with the ring gear C.

The control lever means can for example be a control lever comprising a projection such as a ramp, and comprising a second part which is situated between the lower end of the lever 3 and the projection, positioned between the two plates of the ring 26 which is integral in translation with the drive element. This control lever is designed in a first stage to have the projection in contact with the thrust plate 235, in order to thrust the drive part 23, and in a second stage, as a result of the rotation of the lower part of the control lever 3, for the second part to come into contact with the thrust plate 265, in order to thrust the drive element 22. According to another example, not represented, the second part can be a ring which is in pivot connection with the lower part of the lever 3 situated between the two plates 265, 264 of the ring 26 which is integral with the drive element.

In this example, the control lever can comprise on its lower part two bars on which a half-ring is mounted in pivot connection. The two bars and the top part of the lever form a fork, wherein the two bars surround a portion of the half-ring and the ring 26. The half-ring is mounted on the interior of the bars, in order to make it possible to thrust the drive element by means of the thrust plate 265. In other words, the half-ring comprises a part between the bars and the ring 26. The two bars additionally comprise a projection which is designed to thrust the thrust plate 235 of the drive part 23.

The projections are designed to thrust the thrust plate 235 from the position of rest (in which the contactor 4 is not supplied with power), as far as a position in which the lever is in a position corresponding to the pinion in a position in which it is at least partly engaged with the ring gear.

The half-ring is designed to thrust the drive element 22 by means of the thrust plate 265 of the ring 26, when the lever is in a position corresponding to a position of the pinion in which it is at least partly engaged with the ring gear.

According to another example of the control lever means, the half-ring is a ring which encircles the ring 26.

According to another example, not represented, the control lever means can comprise two levers, wherein a first lever is designed in its lower part to thrust the thrust plate 235 in order to advance the drive part towards the front bearing, and wherein the second lever is designed to displace the drive element relative to the drive part, in order to couple it with the drive part. In this case, the second lever can be controlled by a second control rod which is connected to the mobile core, or directly on the mobile core, or also by another contactor.

In the case in which the second lever is connected to the mobile core, the second lever intervenes when the tooth-against-tooth spring 46 is compressed, i.e. when the mobile core continues to advance, whereas the pinion is blocked in translation.

In the uncoupled position, the play A defined in the description which describes the first embodiment is situated between the pressure plate 245a and the reaction plate 245b. In this case, in FIG. 4, the play A is situated between the pressure plate 245a and a disc of the coupling system.

In the coupled position, the play A is situated between the shoulder 22c and the thrust plate 235. FIG. 5 represents the starter drive unit 20 with its drive element 22 in this position.

The control lever means acts in two stages on the starter drive unit.

In a first stage, the control lever means thrusts the drive part 23 according to the axis X by means of the thrust plate 235, as far as a predetermined position of the drive part relative to the drive shaft, which can correspond to a tooth-against-tooth position. The drive element 22 is thus not yet in the coupled position.

In a second stage, the control lever means thrusts the thrust plate 265 until the coupling system is in an engaged position.

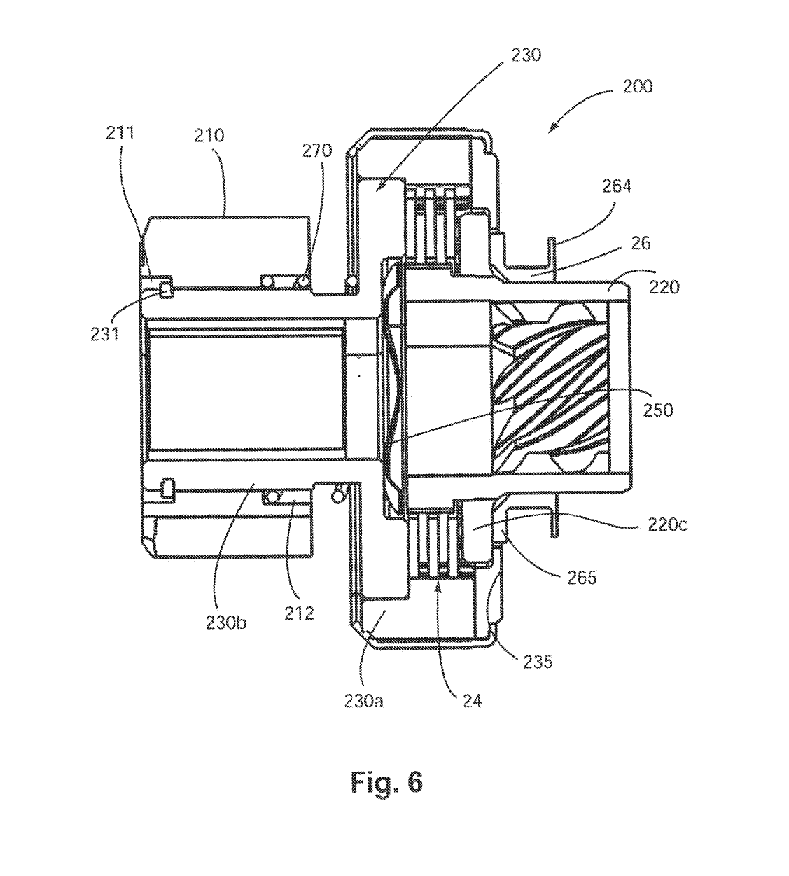

A starter drive unit 200 according to a third embodiment represented in FIG. 6 will now be described.

The starter drive unit 200 is different from the starter drive unit 20 for the elements described hereinafter. Elements which are identical have the same reference number. FIG. 6 represents the starter drive unit 200 according to an axial cross-section.

The starter drive unit 200 comprises a drive part 230 with an axis X which can be mounted on a drive shaft, not represented, which is free in rotation relative to the latter. The starter drive unit 200 additionally comprises a pinion 210. Contrary to the last embodiment, the pinion 210 is mounted such as to be mobile on the drive part 230.

The pinion 210 is integral in rotation relative to the drive part 230, and is mobile in translation according to the axis X, relative to the drive part 230.

The drive part 230 comprises a skirt 230a which is identical to that of the embodiment in FIG. 4.

The pinion 210 comprises a bore with three inner peripheral surfaces with different diameters, i.e. a first inner periphery which is situated at the front of the pinion and surrounds a first portion 211 of the bore, a second, central inner periphery which is situated between the two other inner peripheries and surrounds a second portion 212 of the bore, and has a smaller diameter than the other two, rear inner peripheries, and a third inner periphery, which is situated at the rear and surrounds a third portion 213 of the bore. The central periphery has a diameter which is larger than the outer diameter of a portion 230b of the front part of the drive part 230, such that the pinion 210 can slide on a portion of the drive part 230.

The pinion 210 and the drive part 230 each comprise respectively on the central inner periphery and outer periphery of the front portion 230b at least one corresponding ribbing, not represented, which makes it possible to couple the pinion 210 and the drive part 230 in rotation, and permits translation according to the axis X of the pinion 210 relative to the drive part 230.

The ribbing can for example consist of two grooves and a key mounted in the two grooves, or for example a lug on the inner periphery of the pinion inserted in a groove which accommodates the axis X on the outer periphery of the drive part 230.

The drive part 230 additionally comprises a stop 231 on its front end, which can abut the pinion 210. This stop 231 makes it possible to stop the translation forwards of the pinion 210 relative to the drive part 230.

In this case, the starter drive unit 200 represented comprises a stop 231 with an outer diameter which is smaller than the diameter of the first inner periphery, in order to make it possible to enter into the first portion 211 of the bore in the pinion 210. The outer diameter of the stop 231 is larger than the inner central periphery of the pinion 210, in order to make it possible to abut an inner shoulder which is situated between these two peripheries. The stop 231 makes it possible to stop the translation of the pinion 210 forwards. This first inner periphery thus makes it possible to obtain a starter drive unit 200 which is more compact axially.

The starter drive unit 200 comprises a tooth-against-tooth spring 270, which is mounted around the drive part 230, between the pinion 210 and the skirt 230a. In the case of the tooth-against-tooth position, the spring 270 allows the drive part 230 to continue to advance.

In this case, the starter drive unit 200 represented comprises a tooth-against-tooth spring 270 which is mounted partly in the third, rear portion 213 delimited by the third inner periphery of the bore in the pinion 210. The tooth-against-tooth spring 270 is supported firstly against an inner shoulder of the pinion 210, situated between the central periphery and the third periphery, and secondly against a radial surface of a shoulder of the skirt 230a situated between the pinion 210 and the drive element 220.

The tooth-against-tooth spring 270 thus comprises a part which is surrounded by the third inner periphery. This makes it possible to reduce the axial size of the machine.

The starter drive unit 200 additionally comprises a clutch system 24 which is identical to that of the starter drive unit 2 represented in FIG. 2a, and the starter drive unit 20 represented in FIGS. 4 and 5.

The pinion 210, the drive part 230, the tooth-against-tooth spring 270 and the clutch system 24 are represented in cross-section according to the axis X.

The third embodiment additionally comprises a drive element 220 which is identical to the drive element 22, except that it does not comprise a shoulder at its front end. According to an example of this embodiment of the starter drive unit 200, the drive element 220 is replaced by the drive element 22 of the second embodiment.

In this embodiment, the clutch system 24 operates differently from the clutch system 24 of the other embodiments, in that the clutch system 24 couples the drive part 230 with the drive element 220, when the drive part 230 is blocked in translation relative to the drive shaft 15, by means of a stop mounted on the drive shaft.

The starter drive unit 200 comprises a return means which is identical to that of the second embodiment, i.e. a spring washer 250. The spring washer 250 is inserted in a hollow part of the drive part 230, into which a front part of the drive element 220 is introduced, when it goes from the uncoupled position to the coupled position.

In FIG. 6, the starter drive unit 200 has its clutch system 24 in the disengaged position.

In this embodiment, the starter drive unit 200 comprises a thrust plate 235 and a ring 26 comprising a draw plate 264 and a thrust plate 265, as in the second embodiment. The ring 26 is also mounted at least integrally in translation with the drive element 220. As in the second embodiment, the thrust plate 265 of the ring 26 has an outer diameter which is smaller than the smallest inner diameter of the thrust plate 235, which is integral at least in translation with the drive part 230, such that part of the ring can be inserted in the casing of the skirt 230a.

Similarly, as in the second embodiment, the smallest inner diameter of the thrust plate 235, which is integral at least in translation with the drive part 230, is larger than the largest diameter of the shoulder 220c, thus allowing the thrust plate to thrust the drive element 220, when it is thrust by the control lever means.

The control lever means is not represented. The lever means can be identical to that described previously, thus making it possible to thrust the thrust plate 235 in a first stage and to thrust the thrust plate 265 in a second stage. The lever means is mounted in the place and instead of that in FIG. 3, such that the upper end(s) of the lever, not represented, can be displaced by the electromagnetic contactor 4 in FIG. 3.

In a first stage, the control lever means 30 thrusts the drive part 230 according to the axis X by means of the thrust plate 235, to a position of the drive part which is predetermined relative to the drive shaft, and can correspond to a tooth-against-tooth position. The drive element 220 is thus not yet in the coupled position.

In a second stage, the control lever means thrusts the thrust plate 265 until the coupling system is in an engaged position.

The tooth-against-tooth spring 270 has rigidity which is greater than that of the return spring 250. When the pinion is tooth-against-tooth, this allows the lever means to advance the drive element relative to the drive part, before the tooth-against-tooth spring 270 is compressed.

Thus, when the rotary electrical machine 1 begins to rotate, the drive element is rotated, and rotates the pinion, since the coupling system is active. Thus, as is known, by rotating, the pinion 210 engages with the teeth of the ring gear C. The spring 270 then makes it possible to thrust the pinion to the engaged position.

According to another embodiment, not represented, the return means is situated between the thrust plate 235 which is integral with the drive part, and the shoulder 22C of the drive element. In this example, the return means draws the drive element and the drive part in the direction of the uncoupled position. There is thus no longer a return means situated at the front end of the drive element. In this example, the drive means comprises a first and a second part which are integral in translation respectively with the drive element and with the drive part, in order to draw these towards one another so as to displace the drive element to the uncoupled position. On the other hand, the return means must be separated in rotation from the drive element and/or the drive part, in order to allow this element and/or part to rotate relative to one another. For example, one of the ends can be inserted in a groove in the drive element or in the drive part.

According to another example of the second and third embodiments, the thrust plate 265 of the ring 26 is different, in that the outer diameter of the thrust plate 265 of the ring is larger than the outer diameter of the thrust plate 235. In this example, the distance according to the axis X between the thrust plate 235 and the thrust plate 265, when the shoulder 22c touches the thrust plate 265, must be larger than the play A.

According to another example of the embodiments of the invention, the starter drive unit is not of the disc type, but has a frusto-conical cone. A starter drive unit of this type is described in patent application WO2006/100353, or is like the starter drive unit represented in FIG. 8 of document FR1056174. The drive part comprises a skirt comprising an inner periphery in the form of a concave cone which is cut perpendicularly to the axis of revolution, at its top, thus forming a cylindrical surface, and the drive element comprises a shoulder with a surface in the form of a convex cone which is complementary to the inner conical surface of the skirt of the drive part, which is cut perpendicularly to the axis of revolution, at its top, thus forming a second cylindrical surface. These surfaces in the form of a convex and concave cone form respectively pressure and reaction plates, each comprising friction linings. The return means can be situated in a compression state between the drive element and the drive part, between the cylindrical surface and the second cylindrical surface, in order to thrust the drive element in the direction of the uncoupled position.

1. Friction starter drive unit for a starter, comprising:
a pinion (21) comprising a bore for the passage of a drive shaft (15);
a drive part (23) comprising a bore for the passage of a drive shaft (22), the drive part (23) being mounted integrally in rotation with the pinion;
a drive element (22) comprising a bore for the passage of a drive shaft (15) of a starter, which is mobile in translation according to the axis X of the bore relative to the drive part (23), between an uncoupled position and a coupled position;
a friction coupling means (24) comprising a friction clutch comprising a plate (245a) for pressure on the drive element and a plate (245b) for reaction on the drive part (23), and wherein the friction clutch is a disc clutch which is designed to couple the drive element (22) with the drive part (23) when the drive element is in the coupled position, wherein the starter drive unit comprises a return means which exerts a force on the drive element, and a force on the drive part in the direction of a position of uncoupling, as far as a position of uncoupling in rotation, and wherein, in this position, the drive element and the drive part are immobile in translation relative to one another by means of the force of the return means, whilst being free in rotation relative to one another.

2. Starter drive unit according to claim 1, wherein the drive part comprises a part which forms a casing which surrounds part of the drive element, wherein the starter drive unit additionally comprises a ring which is secured to the drive part, comprising a surface which faces a surface of a shoulder of the drive element which is enclosed in the casing, and wherein, in the uncoupled position, the return means (25) exerts a force on the drive element against the surface of the ring.

3. Starter drive unit according to claim 1, wherein the return means (25) is mounted with compression against a radial inner surface of the drive part (23) and a front surface which forms an axial end of the drive element (22) situated in the interior of the drive part, in order to separate the drive element (22) from the drive part (23).

4. Starter drive unit according to claim 3, wherein the coupling means comprises a friction clutch, comprising a plate (245a) for pressure on the drive element and a plate (245b) for reaction on the drive part (23).

5. Starter drive unit according to claim 4, wherein the friction clutch is a disc clutch.

6. Starter drive unit according to claim 4, wherein the pressure plate (145a) and the reaction plate (245b) each comprise a friction skirt which is designed to be placed one against the other in the coupled position.

7. Starter drive unit according claim 1, wherein the drive part (23) comprises a first part on which the pinion is mounted, and a second part which surrounds a part of the drive element, wherein the pinion slides on the first part of the drive part, and is integral in rotation in both directions with the drive part, and the starter drive unit additionally comprises a spring which is mounted between the radial rear surface of the pinion which faces the radial front surface of the second part of the drive part.

8. Starter drive unit according to claim 1, wherein the pinion is secured on a part of the drive part.

9. Starter drive unit according to claim 1, wherein the return means is a spring washer.

10. Starter comprising a drive shaft and a starter drive unit according to claim 1, mounted integrally in rotation on the drive shaft, and mobile on the latter between a disengaged position and an engaged position.

11. Starter according to claim 10, comprising:
a control lever which is mobile from an activated position to a deactivated position;
a means for activation of the control lever;
an electric motor to rotate the drive shaft,
wherein the starter drive unit comprises a withdrawal shoulder and at least one advance shoulder which is designed to co-operate with part of the control lever, wherein the return means is designed to exert a force on the drive element towards the uncoupled position, and wherein the force of the return means is lower than the force exerted by the lever on the drive element, when the latter is in the coupled position.

12. Starter according to claim 11, wherein the part of the lever which co-operates with the starter drive unit comprises projections which are designed in order:
in a first stage, when the control lever is displaced from its deactivated position to the activated position, to thrust the drive part onto a surface of a shoulder which is integral with the drive part, in the direction of the engaged position, opposite the electric motor; and
in a second stage, at a predetermined distance corresponding to the pinion engaged in the ring gear, to thrust the starter drive unit, onto a surface of advance of a shoulder which is integral with the drive element, towards the engaged position, and wherein:
when the pinion is blocked in translation towards the engaged position, or is in the engaged position, the part of the lever is designed to thrust on the surface of a shoulder which is integral with the drive element, in the direction of the coupled position, towards the drive part which compresses the return means; and
wherein the return means is designed such as, when the control lever is in the deactivated position, to maintain the drive element in the uncoupled position, against a shoulder which is integral in translation with the drive part.

13. Starter according to claim 12, comprising:
a housing;
a drive shaft (15) comprising an axis X, which is rotated by the housing (11) by means of a front bearing (11A);
an electric motor M comprising a rotor shaft, which is coupled in rotation with the drive shaft (15);
a starter drive unit comprising:
a drive element which is mounted by means of ribbing on the drive shaft;
a pinion which can be displaced according to the axis X, relative to the drive shaft, and can be free in rotation relative to the drive shaft;
a drive part which is integral in rotation with the pinion, comprising a skirt which surrounds a part of the drive element;
a system for coupling between the drive element and the pinion;
a thrust plate which is secured to the skirt of the drive part, which closes the skirt and encloses the part of the drive element in the skirt;
wherein the drive element is mobile in translation according to the axis X, relative to the drive part, between a so-called coupled position in which it activates the coupling system, and an uncoupled position in which the coupling system is deactivated;
a plate which forms a shoulder relative to the drive element, and is integral in translation with the drive element;
a control lever means which is designed to make it possible:
in a first stage, to displace the drive part according to the axis X in the direction of the front bearing, relative to the drive shaft, by thrusting the thrust plate; and
in a second stage, to displace the drive element according to the axis X in the direction of the front bearing, relative to the drive part, as far as the coupled position.
